(19) United States
(12) Patent Application Publication
(10) Pub. No.: US 2008/0236716 A1
(43) Pub. Date: Oct. 2, 2008

(54) Elastomer Having Feather Material

(76) Inventors: Brian R. Bergman, Clermont-Ferrand (FR); Stephen Travis Mills, Greenville, SC (US); Rodney R. Bailey, Simpsonville, SC (US)

Correspondence Address: MICHELIN NORTH AMERICA, INC.;INTELLECTUAL PROPERTY DEPARTMENT, MARC BLDG 31-2, 515 MICHELIN ROAD, GREENVILLE, SC, 29605, US

(21) Appl. No.: 11/694,512

(22) Filed: Mar. 30, 2007

(51) Int. Cl. B60C 17/04; C08L 89/04

(52) U.S. Cl. 152/517; 152/564; 524/10

(57) ABSTRACT

Rubber compositions having feather material incorporated therein and products formed from these rubber compositions, an example being a cross-linkable or cross-linked rubber composition having an essentially unsaturated rubber elastomer and a filler that is selected from carbon black, silica or combinations thereof with between 1 and 60 phr of feather material, the feather material having feather barbs with a diameter of about 5 μm and a length of between about 5 and 25 mm. Other embodiments include, with the feather barbs, the feather quills wherein at least a portion of the feather barbs are not separated from the feather quills. The feather material may include a coupling agent comprising a first moiety that is reactant with the rubber elastomer and a second moiety that is reactant with the feather material.

### BACKGROUND OF THE INVENTION

1. Field of the Invention

This invention relates generally to elastomeric materials and more specifically, to rubber elastomers mixed with feather material and articles made therefrom.

2. Description of the Related Art

It is known that some 2 to 3 billion pounds of feather fiber waste is generated in the United States each year from the chicken industry. It is further recognized that it would be beneficial to find uses for this waste product.

It is known to use animal waste products in rubber compositions. For example, in European Patent Application EP 0 728 807 it is disclosed that mixing keratin fibers such as wool fibers, animal hair or animal bristles into rubber compositions useful for tire treads improve the winter properties of the tread mixture, especially the gripping properties, for example, traction on snow and braking on snow and ice.

U.S. Pat. No. 5,852,079 also discloses the use of animal fibers in rubber compositions useful for tire treads. This patent discloses that treads made from a rubber composition having both cellulose fibers (selected from cotton fibers and coco fibers) and keratin fibers (selected from wool fibers, animal hair and animal bristles) provides a significant improvement especially for traction on snow and braking on ice.

### SUMMARY OF THE INVENTION

The present invention provides rubber compositions having feather material incorporated therein and products formed from these rubber compositions. In one embodiment, a rubber composition is a cross-linkable or cross-linked rubber composition having an essentially unsaturated rubber elastomer and a filler that is selected from carbon black, silica or combinations thereof. In addition to these components, the rubber composition also includes between 1 and 60 phr of feather material, the feather material comprising feather barbs, the feather barbs having a diameter of about 5 μm and a length of between about 5 and 25 mm. Other embodiments additionally include the feather quills, wherein at least a portion of the feather barbs are not separated from the feather quills.

Another embodiment of the present invention includes a coupling agent comprising a first moiety that is reactant with the rubber elastomer and a second moiety that is reactant with the feather material. The coupling agent may have a formula X—R—Y, wherein X is the first moiety reactant with the elastomer, Y is the second moiety reactant with the feathers and R is selected from C₁ to C₂₀ hydrocarbon moieties. The feather material may be pretreated with the coupling agent.

Another embodiment of the present invention includes articles made out of the rubber compositions described above including, for example, a tire. The rubber composition may be used for the manufacture, for example, of a sidewall run flat support member of a run flat tire comprising a sidewall run flat support member.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a cross-sectional view of one-half of a run flat tire having a sidewall support in accordance with an exemplary embodiment of the present invention.

### DETAILED DESCRIPTION OF PREFERRED EMBODIMENTS

The present invention provides elastomer compositions and articles made therefrom. Particular embodiments of the present invention include curable elastomer compositions that are cured to provide useful articles that are embodiments of the present invention. The rubber elastomer compositions of the present invention include both cross-linkable and cross-linked rubber compositions, i.e., the compositions may be uncured or cured. As such, articles may be made from either the cured or uncured rubber compositions and if made of the uncured, they may be later cured to provide articles made of the cured rubber composition.

Particular embodiments of the present invention include a curable elastomer composition having a rubber elastomer mixed with feather material, such feather material including feather barbs with or without feather quills. The rubber elastomer may be an essentially unsaturated rubber elastomer. The curable rubber composition further includes an effective amount of a curing agent for curing the curable elastomer into a cured elastomer composition. The curable elastomer composition further includes a filler selected from carbon black, silica or combinations thereof.

Feather material mixed into the elastomer composition are effective for both reducing the density of the cured elastomer as well as providing a surprising increase in rigidity and a decrease in the hysteresis of the cured elastomer. Feathers contain keratin, which is a biopolymer of mammalian and avian species. For example hair, wool and claws of mammal species are composed of the protein keratin just as feathers of avian species are composed of the keratin protein. The keratin structure can result in very different macroscopic morphology and physical structures due to the chemistry of the starting biopolymer.

Feathers are the external outer covering of the body of birds. These feathers include a shaft or quill that bears a series of barbs on each side of the shaft. The barbs may bear barbules which in turn may bear barbicels commonly ending in hooked hamuli interlocking with the barbules of an adjacent barb to link the barbs into a continuous vane. If examined under a scanning electron microscope, the cross section of one barb on a feather is shown to have a grain structure, which may explain why the feather barb is very strong.

The protein structure of feather keratin consists of a sequence of 95 amino acids, about half that are hydrophilic and about half that are hydrophobic. The surface properties of the feathers are dependent on the degree of hydrophobic amino acids that are exposed internally or externally relative to the helix structure of the keratin protein. The resulting surface properties of the feathers impact the polymer interactions with which they are mixed.

Suitable feathers may be selected from any suitable aviary species and includes, for example, chicken feathers, duck feathers, turkey feathers, pigeon feathers, goose feathers and combinations thereof. The feather material added to the curable elastomer composition may be feathers that are whole or chopped. Other embodiments include using feather material that is only parts of the feathers, e.g., just the feather barbs with the quills removed. In particular embodiments of the present invention, just the barbs are utilized, such barbs being between about 5 and 25 mm long with a diameter of about 5 μm. Other embodiments include barbs of between 5 and 10 mm long. The barbs, as well as the whole feathers, may be chopped or cut to obtain a desirable length.

Feather materials are available from, for example, MaXim LLC of Pasadena, Calif. and Featherfiber of Frontenac, Kans. Feather materials can be purchased either with or without quills.

While the amount of feather material that is added to the elastomer composition is not limited, particular embodiments of the curable elastomer composition include between 1 and 60 phr of feather material, i.e., feathers and/or feather parts. For example, the feathers and/or feather parts may be feather barbs that are separated from the quills, chopped feathers, whole feathers or combinations thereof, all or any of which have been chopped or otherwise length-controlled. Particular embodiments of the curable elastomer composition include between 1 and 40 phr of feather barbs, other feather material or combinations thereof or alternatively, between 5 and 20 phr. Other embodiments include between 5 and 35 phr of feather barbs, other feather material or combinations thereof or alternatively, between 5 and 30 phr.

Particular embodiments of the present invention may further include the addition of other filler material, such as carbon black, silica or combinations thereof, to the elastomer composition. There are many different types of carbon blacks and silica that may be used with elastomers and the selection of which filler to use in a particular application is well known to those having ordinary skill in the art. For example, in the manufacture of tires, carbon blacks are selected for use in the tires based upon the preferred characteristics of the rubber mix. For example, a truck tire tread may be manufactured from a rubber mix containing a carbon black having the physical properties of a rubber black assigned to the N200 classification series that is provided under ASTM designation D1765 for carbon blacks. By contrast, the carcass of the tire may be manufactured from a rubber mix containing a carbon black having the physical properties of the N600 carbon black classification series. Such selections are made based upon the known effects that different classes of carbon black have on the physical properties of the rubber such as, for example, the hysteresis and rigidity of the mix

The total filler used in the curable elastomer composition includes the total of the feather material, the carbon black and the silica. Particular embodiments of the present invention include between 1 and 200 phr of silica, carbon black or combinations thereof with alternative embodiments having between 10 and 75 phr of silica, carbon black or mixtures thereof or between 5-50 phr of silica, carbon black or combinations thereof. These ranges are meant to be only examples and are not meant to limit the invention and any useful range of these materials may be utilized for different embodiments of the invention.

Without limiting the invention, embodiments include, for example, curable elastomer compositions having between 5 and 80 wt. % of the total filler as feather material. Other embodiments have between 10 and 60 wt. % of the total filler as feather material and yet other embodiments have either between 10 and 30 wt. % or between 20 and 45 wt. % of the total filler as feather material. The invention is not limited to these ranges of materials and any weight percent of feather fiber in the filler may be added to suit a particular application.

The rubber elastomers that are useful for particular embodiments of the present invention include natural rubbers, synthetic rubbers or combinations thereof. Particular embodiments of the present invention include rubber elastomers that are essentially unsaturated diene elastomers. Diene elastomers or rubber is understood to mean those elastomers resulting at least in part (i.e., a homopolymer or a copolymer) from diene monomers (monomers bearing two double carbon-carbon bonds, whether conjugated or not). Essentially unsaturated diene elastomers are understood to mean those diene elastomers that result at least in part from conjugated diene monomers, having a content of members or units of diene origin (conjugated dienes) that are greater than 15 mol. %.

Within the category of essentially unsaturated diene elastomers, highly unsaturated diene elastomer is understood to mean in particular a diene elastomer having a content of units of diene origin (conjugated dienes) that is greater than 50 mol. %.

The rubber elastomers suitable for use with particular embodiments of the present invention include highly unsaturated diene elastomers, for example, polybutadienes (BR), polyisoprenes (IR), natural rubber (NR), butadiene copolymers, isoprene copolymers and mixtures of these elastomers.

Also suitable for use in particular embodiments of the present invention are rubber elastomers that are copolymers and include, for example, butadiene-styrene copolymers (SBR), butadiene-isoprene copolymers (BIR), isoprene-styrene copolymers (SIR) and isoprene-butadiene-styrene copolymers (SBIR) and mixtures thereof.

Also suitable for use in particular embodiments of the present invention are rubber elastomers that that include, for example, natural rubber, synthetic cis-1,4 polyisoprenes and mixtures thereof. These synthetic cis-1,4 polyisoprenes may be characterized as possessing cis-1,4 bonds at more than 90 mol. % or alternatively, at more than 98 mol. %.

Diene elastomers such as butyl rubbers, nitrile rubbers or copolymers of dienes and of alpha-olefins of the ethylene-propylene diene terpolymer (EPDM) type or the ethylene-vinyl acetate copolymer type do not fall within the preceding definition of essentially unsaturated diene elastomers, and may in particular be described as “essentially saturated” diene elastomers (low or very low content of units of diene origin, i.e., less than 15 mol. %. Such elastomers are useful in particular embodiments of the present invention.

Adding feather material to rubber formulations are effective in providing improved reinforcement properties of the rubber formulations. However, to make such rubber formulations useful for forming sidewall supports in run flat tire applications or other applications requiring a lower hysteresis, it is useful to couple the protein in the feather material to the elastomer.

Coupling agents that may be used for coupling the protein in the feather material with the rubber matrix include those that have both a first moiety to interact with the feather protein and a second moiety to interact with the elastomer. The coupling agent is of the formula shown in Equation (1):

X—R—Y (1)

wherein X is the first moiety that interacts with the elastomer, Y is the second moiety that interacts with the keratin protein-based feather material and R is a hydrocarbon moiety.

In particular embodiments of the present invention, R may be selected from C₁ to C₂₀ moieties, including alkyl radicals, straight chained or branched. In other embodiments, R may be selected from C₃ to C₆ cycloalkyl moieties, aryl moieties such as phenyl, and alkaryl moieties such as tolyl.

In particular embodiments of the invention, the first moiety X may be selected from sulfides such as, for example, polysulfides, tetra sulfides, vinyl sulfides and mercapto groups. In particular embodiments of the invention, the second moiety Y may be selected from carboxy, amino, nitrobenzamide, ester and acrylate groups. Examples of suitable coupling agents that conform to the general formula shown in equation (1) include, for example, 1-mercapto-6-carboxy-hexane, 1-mercapto-6-amino-hexane, 1-mercapto-5-nitrobenzamide-pentane, 1-mercapto-8-methacrylate-octane, and 2-hexene-6-carboxylic acid.

Although not limiting the invention, treating the feather material with the coupling agent is desirable to minimize the hysteresis of an elastomer composition having feather material. The feather material may be treated with the coupling agent prior to mixing the pretreated feather material with the rubber composition. Pretreating may be accomplished, for example, by dipping the feather material into a solution containing the coupling agent, by spraying the coupling agent onto the feather material either neat or in a solution or by vapor deposition. Alternatively, depending on the coupling agent and the internal mixer used to mix the elastomer composition, the coupling agent may be added separately to the mixture for in situ coupling of the feather material and the elastomer matrix.

An example of a process that may be used to pre-treat the feather material includes preparing a coupling agent solution using a solvent such as, for example, isopropyl alcohol, dipping the feather material into the solution, and then drying the feather material to remove the carrier solvent. The solution may, for example, have between about 1 and 5 mole % of the coupling agent.

As noted above, though not preferred, the coupling agent may be added to the banbury mixer with untreated feather material to treat the feather material in situ during the mixing process. Such a process, as well as the pretreatment described above, provides coupling agent-modified feather material.

Particular embodiments include a rubber composition having feather material comprising about the coupling agent bonded to the feather material in amount that is less than about 5 wt. % of the feather material or alternatively, between about 0.1 and 5 wt. % of the feather material. Other embodiments may include feather material having coupling agent bonded to the feather material that is between 0.5 and 3 wt. % of the feather material or alternatively, between 1 and 3 wt. % or between 1 and 5 wt. % or less than 3 or 1 wt. %.

The elastomer compositions disclosed herein may be used for various elastomeric products such as a tread compound, undertread compound, sidewall compound, wire skim compound, inner liner compound, bead, apex, any compound used in a tire carcass, including carcass reinforcement and in other components for tires, industrial rubber products, seals, timing belts, power transmission belting, and other rubber goods. As such, the present invention includes products made from the rubber elastomer compositions disclosed herein.

The elastomer composition of the present invention is particularly suited for use in tires that are intended to bear heavy loads including, for example, truck tires and tires for heavy vehicles. Such tires typically comprise reinforcements which are formed of reinforcing threads or plies of metal wires coated with elastomers. More precisely, these tires comprise, in their bottom zone, one or more bead wires, a carcass reinforcement extending from one bead wire to the other and, in their crown, a crown reinforcement comprising at least two crown plies. Such structures and tire architecture are well known to one having ordinary skill in the art and therefore, a detailed disclosure of such information is neither required nor proper.

Particular embodiments of the present invention further include sidewall supports for vehicle tires, especially for those tires that are suitable for run-flat operation. The physical characteristics of the elastomer composition disclosed herein provide the benefits that are sought in run-flat tire applications. Because a run-flat tire must operate over a significant distance in a non-inflated state while still providing support for a vehicle, rigidity and hysteresis properties of the materials making up the sidewall are critical. As known to those having ordinary skill in the art, run-flat tires are designed to operate for a suitable distance after loss of normal inflation pressure.

The supports are made a part of the sidewall by tire building methods known to those having ordinary skill in the art and the known steps that are a part of such methods or processes are not a part of the present invention.

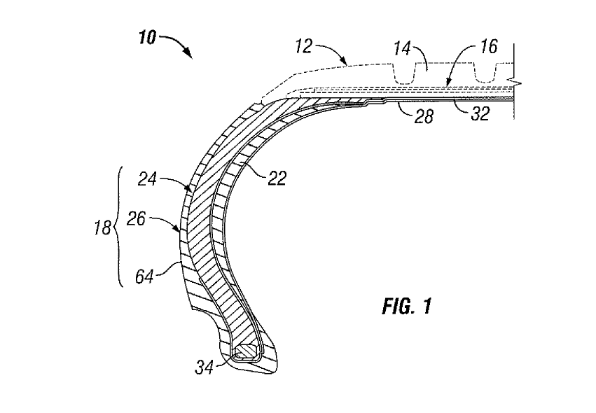

FIG. 1 is a cross-sectional view of one-half of a run-flat tire having a sidewall support. It should be noted that the tire shown herein is exemplary only and is not meant to limit the invention to run-flat tires having only the architecture shown here. The run-flat tire 10 includes a crown portion 12 with a tread 14 and a tread reinforcing package 16. The run-flat tire 10 further includes a sidewall 18 having a crescent shaped reinforcing member 22 with a supportive complex 24 and a protective complex 26. An inner liner 28 and tire casing ply 32 wrapped around a bead core 34 are also included as typical in a pneumatic vehicle tire.

The present invention farther includes methods for making tires and other products having the elastomer composition in accordance with particular embodiments of the present invention. One method includes the steps of mixing the elastomer composition comprising the rubber elastomer, the curative agents, the carbon black and/or silica and the feather material in a banbury mixer. The method further includes forming one or more tire components comprising the mixed elastomer composition and then assembling the tire that comprises the one or more tire components comprising the mixed elastomer composition. Particular embodiments of the present invention further include curing the tire. Examples of the one or more components include, for example, sidewall support members, tread, undertread, carcass, carcass reinforcement and combinations thereof.

The present invention does not include the known steps of the method for assembling a tire or for curing a tire. One having ordinary skill in the art is knowledgeable of such methods or processes and therefore, a detailed disclosure of such information is neither required nor proper.

The invention is further illustrated by the following examples, which are to be regarded only as illustrations and not delimitative of the invention in any way. The measurements of physical properties were obtained as follows:

Modulus of Elongation: The moduli of elongation were measured at 10% (M10), 50% (M50) and 100% (M100) at a temperature of 23° C. in accordance with ASTM D412 (1998) on ASTM C test pieces. These are true secant moduli in MPa, that is to say the secant moduli calculated reduced to the real cross-section of the test piece at the given elongation.

Hysteresis Losses (HL): Hysteresis losses were measured in percent by rebound at 60° C. at the sixth impact in accordance with the following equation (2):

HL(%)=100{(W₀−W₁)/W₁}, (2)

wherein, W₀ is the energy supplied and W₁ is the energy restored.

Elongation to Break Properties: The elongation properties were measured as elongation at break (EB %) and the corresponding elongation stress (ES, MPa), which were measured at 23° C. in accordance with ASTM Standard D412 on ASTM C test pieces.

The dynamic characteristics of the materials were measured on a rotorless shear rheometer and more specifically, on an RPA 2000 rheometer manufactured by Alpha Technologies. For the examples provided below, the samples were cured in the RPA 2000 at 150° C. for 25 minutes at a frequency of 1.67 Hz and 0.05 deg arc. A strain sweep (0-40% maximum strain) was then performed at 30° C. at a frequency of 10 Hz.

### EXAMPLE 1

This example provides comparisons of the physical properties of various cured elastomer compositions that contain chopped feathers. The formulations of the different compositions are shown in Table 1. The protective agents shown in Table 1 were antioxidants and antireversion agents, the curatives were sulfur, retarders, accelerators and catalysts and the coupling agents were silane coupling agents for the silica, all known to those having ordinary skill in the art.

TABLE 1
Rubber Composition Formulations

| | Mix Number | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Natural Rubber | 80 | 80 | 80 | 80 | 80 | 80 | 80 | 80 | 80 | 80 | 80 | 80 |
| Polybutadiene (BR) | 20 | 20 | 20 | 20 | 20 | 20 | 20 | 20 | 20 | 20 | 20 | 20 |
| N650 Carbon Black, phr | 35 | 35 | 35 | 35 | 35 | 30 | 25 | 20 | 15 | 40 | 45 | 55 |
| Silica, phr | 15 | 15 | 15 | 15 | 15 | 15 | 15 | 15 | 15 | 15 | 15 | 15 |
| Protective Agents, phr | 6.5 | 6.5 | 6.5 | 6.5 | 6.5 | 6.5 | 6.5 | 6.5 | 6.5 | 6.5 | 6.5 | 6.5 |
| Curatives, phr | 12.8 | 12.8 | 12.8 | 12.8 | 12.8 | 12.8 | 12.8 | 12.8 | 12.8 | 12.8 | 12.8 | 12.8 |
| Coupling Agents, phr | 2.2 | 2.2 | 2.2 | 2.2 | 2.2 | 2.2 | 2.2 | 2.2 | 2.2 | 2.2 | 2.2 | 2.2 |
| Feather Material, phr | 0 | 5 | 10 | 15 | 20 | 5 | 10 | 15 | 20 | 0 | 0 | 0 |

Elastomer formulations were prepared by mixing the components given in Table 1, except for the sulfur and the curing agents, in a banbury mixer operating at 55-65 RPM until a temperature of between 155 and 170° C. was reached. The sulfur and curing agents were then added on a roll mill. Vulcanization was effected at 150° C for 25 minutes. The formulations were then tested to measure their physical properties. The physical properties of each of the mixes were determined as described above and the results are shown in Table 2.

TABLE 2
Physical Properties of Cured Elastomer Compositions

| | Mix No. | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Density | 1.13 | 1.12 | 1.11 | 1.10 | 1.09 | 1.11 | 1.09 | 1.07 | 1.05 | 1.14 | 1.15 | 1.17 |
| Density, % Δ | 0.00 | −0.91 | −1.76 | −2.55 | −3.28 | −2.13 | −4.18 | −6.15 | −8.06 | 1.20 | 2.36 | 4.56 |
| M10 (23 C.) | 5.6 | 8.8 | 11.5 | 17.0 | 21.7 | 8.1 | 11.6 | 14.2 | 16.4 | 6.3 | 6.9 | 8.2 |
| M50 (23 C.) | 3.8 | 6.6 | 8.4 | 11.0 | 13.3 | 6.1 | 8.4 | 9.6 | 10.9 | 4.3 | 4.7 | 5.8 |
| M100 (23 C.) | 3.6 | 5.1 | 5.6 | 6.4 | 7.2 | 4.6 | 5.2 | 5.6 | 5.8 | 4.3 | 4.8 | 6.1 |
| HL, % at 60° C. | 9.6 | 15.1 | 16.4 | 17.8 | 19.0 | 14.4 | 16.2 | 16.3 | 16.1 | 10.3 | 11.1 | 11.9 |
| ES (23 C.), MPa | 22.1 | 16.5 | 14.3 | 12.9 | 10.5 | 17.2 | 12.6 | 12.1 | 10.6 | 22.6 | 21.3 | 22.8 |
| EB % (23 C.) | 347 | 276 | 243 | 216 | 173 | 307 | 250 | 251 | 238 | 325 | 291 | 270 |

Perpendicular Direction

| | | | | | | | | | | | | |
|---|---|---|---|---|---|---|---|---|---|---|---|---|
| M10 (23 C.) | 5.4 | 8.5 | 10.4 | 12.4 | 14.3 | 8.4 | 8.9 | 10.0 | 12.8 | 6.4 | 7.2 | 8.6 |
| M50 (23 C.) | 3.7 | 5.3 | 6.1 | 6.9 | 9.1 | 5.1 | 5.2 | 5.7 | 6.4 | 4.4 | 4.8 | 5.9 |
| M100 (23 C.) | 3.50 | 4.55 | 4.73 | 5.06 | 5.76 | 4.11 | 4.01 | 4.08 | 4.21 | 4.33 | 4.83 | 6.16 |
| HL, % at 60° C. | 10.4 | 15.7 | 16.0 | 17.0 | 19.6 | 14.1 | 14.5 | 14.9 | 15.7 | 11.7 | 13.0 | 14.5 |
| ES (23 C.) MPa | 23.7 | 16.0 | 14.5 | 12.7 | 12.9 | 16.1 | 12.8 | 12.6 | 11.2 | 20.7 | 20.7 | 20.9 |
| EB % (23 C.) | 374 | 282 | 267 | 245 | 229 | 304 | 277 | 293 | 287 | 307 | 295 | 253 |

Dynamic Properties at 30° C.

| | | | | | | | | | | | | |
|---|---|---|---|---|---|---|---|---|---|---|---|---|
| G′ @ 40% | .789 | .978 | 1.01 | 1.12 | 1.27 | .906 | .917 | .916 | .920 | .957 | 1.10 | 1.29 |
| G″ @ 40% | .066 | .075 | .091 | .085 | .084 | .072 | .065 | .052 | .045 | .088 | .107 | .151 |
| Tan δ @ 40% | .084 | .078 | .089 | .076 | .066 | .079 | .071 | .057 | .049 | .092 | .097 | .117 |
| G′ @ 10% | .746 | .902 | .975 | 1.08 | 1.22 | .896 | .876 | .852 | .829 | .957 | 1.13 | 1.36 |
| G″ @ 10% | .084 | .104 | 0119 | .133 | .122 | .095 | .088 | .075 | .066 | .138 | .162 | .248 |
| Tan δ @ 10% | .113 | .116 | .120 | .123 | .100 | .106 | .101 | .088 | .079 | .144 | .143 | .183 |

As can be seen from the results shown in Table 2, the addition of chopped chicken feathers significantly increases the modulus of elongation, especially the low strain modulus of elongation (M10). The addition of 20 phr of the chopped chicken feathers resulted in a 287% increase in the M10 while in contrast, the control mix No. 12 had only a 46% increase in M10 with the addition of 20 phr of the carbon black N660.

As for the dynamic properties G′, G″ and Tan δ, the addition of feather material resulted in increased G′ along with lower Tan δ at 40% strain and also increased G′ with approximately iso-Tan δ at 10% strain. The formulations 6-9 at constant filler phr resulted in an approximately iso-modulus G′ along with a lower Tan δ at 40% strain and also slightly lower G′ and lower Tan δ at 10% strain but most importantly, these were achieved with an 8% density reduction.

The terms “comprising,” “including,” and “having,” as used in the claims and specification herein, shall be considered as indicating an open group that may include other elements not specified. The term “consisting essentially of” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A cross-linked or cross-linkable rubber composition, comprising:
an essentially unsaturated rubber elastomer;
a filler selected from carbon black, silica or combinations thereof; and
between 1 and 60 phr of feather material, wherein the feather material comprises feather barbs having a diameter of about 5 μm and a length of between about 5 and 25 mm.

2. The rubber composition of claim 1, further comprising:
feather quills, wherein at least a portion of the feather barbs are not separated from the feather quills.

3. The rubber composition of claim 2, wherein the feather quills and the feather barbs are chopped feathers.

4. The rubber composition of claim 1, further comprising:
a coupling agent comprising a first moiety that is reactant with the rubber elastomer and a second moiety that is reactant with the feather material.

5. The rubber composition of claim 4, wherein the coupling agent has the formula:
X—R—Y, wherein X is the first moiety reactant with the rubber elastomer, Y is the second moiety reactant with the feather material and R is selected from C₁ to C₂₀ hydrocarbon moieties.

6. The rubber composition of claim 5, wherein R is selected from C₁ to C₂₀ alkyl moiety, straight chained or branched.

7. The rubber composition of claim 5, wherein R is selected from C₃ to C₆ cycloalkyl moiety.

8. The rubber composition of claim 5, wherein R is selected from aryl radicals or alkaryl moiety.

9. The rubber composition of claim 5, wherein X is a sulfide.

10. The rubber composition of claim 5, wherein Y is selected from carboxy, amino, nitrobenzamide, ester and acrylate groups.

11. The rubber composition of claim 4, wherein the feather material is pretreated with the coupling agent.

12. The rubber composition of claim 1, wherein the rubber composition comprises between 5 and 30 phr of the feather barbs.

13. An article, comprising:
the cross-linked or cross-linkable rubber composition of claim 1.

14. The article of claim 13, wherein the article is a tire.

15. The article of claim 14, wherein the tire is a run flat tire comprising a sidewall run flat support member, the sidewall run flat support member comprising the rubber composition of claim 1.

16. The article of claim 13, further comprising:
the rubber composition of claim 4.

17. A tire, comprising:
the rubber composition of claim 4.

18. The tire of claim 17, further comprising:
a sidewall, the sidewall comprising a support member, the support member comprising the elastomer composition of claim 4.

19. The tire of claim 18, wherein the tire is a run flat tire, the support member being a run flat support member.

20. The tire of claim 17, further comprising:
a tread, the tread comprising the rubber composition of claim 4.
